(19) United States
(12) Patent Application Publication
(10) Pub. No.: US 2015/0359203 A1
(43) Pub. Date: Dec. 17, 2015

(54) FLUID DELIVERY SYSTEM OF AN IN OVO INJECTION APPARATUS

(71) Applicant: Formulatrix, Inc., Waltham, MA (US)

(72) Inventors: Thomas Matthew Hessler, Durham, NC (US); Kabir James Yamana, Cambridge, MA (US)

(21) Appl. No.: 14/696,510

(22) Filed: Apr. 27, 2015

Related U.S. Application Data
(60) Provisional application No. 62/011,620, filed on Jun. 13, 2014.

(51) Int. Cl. A01K 45/00; F04B 53/10; F04B 43/02

(52) U.S. Cl. CPC A01K 45/007; F04B 43/02; F04B 53/10

(57) ABSTRACT

A fluid delivery system implemented within an in ovo injection apparatus is disclosed, wherein the fluid delivery system includes a plurality of membrane valves. In particular, the fluid delivery system includes a diaphragm valve that is used to meter out a precise volume of a treatment substance liquid. Further, the diaphragm valve includes certain standoff features on the surface thereof for reducing or entirely preventing the adhesion of the diaphragm to adjacent surfaces when left idle for an extended period of time, as well as an arrangement of fluid channels in the surface thereof for reducing or entirely preventing the trapping of liquid between the diaphragm and adjacent surfaces. The fluid delivery system includes features contributing to optimized flow characteristics.

### CROSS-REFERENCE TO RELATED APPLICATIONS

The presently disclosed subject matter is related to and claims priority to U.S. Provisional Patent Application No. 62/011,620 entitled “Fluid Delivery System of an In Ovo Injection Apparatus” filed on Jun. 13, 2014; the entire disclosure of which is incorporated herein by reference.

### TECHNICAL FIELD

The presently disclosed subject matter relates generally to fluid delivery systems and more particularly to a fluid delivery system implemented within an in ovo injection apparatus, wherein the fluid delivery system comprises a plurality of membrane valves having anti-adhesion and fluid relief features.

### BACKGROUND

In many instances, it is desirable to introduce a substance into a live avian egg prior to hatch. An injection of various substances into avian eggs is commonly referred to as “in ovo injection.” Such injections have been employed to decrease post-hatch mortality rates, increase the potential growth rates or eventual size of the resulting bird, and even to influence the gender determination of the embryo. Similarly, injections of antigens into live eggs have been employed to incubate various substances used in vaccines that have human or animal medicinal or diagnostic applications. Examples of substances that have been used for, or proposed for, in ovo injection include, but are not limited to, vaccines, antibiotics, and vitamins. In addition, removal of material from avian eggs using similar processes and/or equipment has been employed for various purposes, such as testing and vaccine harvesting.

An egg injection apparatus (i.e., in ovo injection apparatus) may comprise a plurality of injection devices that operate simultaneously or sequentially to inject a plurality of eggs. The injection apparatus may comprise an injection head which comprises the injection devices, and wherein each injection device is in fluid communication with a source containing a treatment substance to be injected. The in ovo injection apparatus conventionally is designed to operate in conjunction with commercial egg carrier carriers or flats. Egg flats utilized in conjunction with an in ovo injection apparatus typically contain an array of pockets that are configured to support a respective plurality of avian eggs in a generally upright orientation. The egg flats may be typically transported through the in ovo injection apparatus via an automated conveyor system for registering the egg flat beneath the injection head for injection of the eggs carried by the egg flat. In ovo injection of substances (as well as in ovo extraction of materials) typically occurs by piercing an egg shell to form an opening (e.g., via a punch), extending an injection needle through the hole and into the interior of the egg (and in some cases into the avian embryo contained therein), and injecting treatment substance(s) through the needle and/or removing material therefrom.

The fluid delivery system for implementation within an in ovo injection apparatus may comprise one or more membrane valves for controlling the flow of fluid therethrough and for controlling the precise amount of treatment substance to be injected into the eggs. However, certain challenges exist with respect to the reliable operation of the membrane valves. In one example, when left idle for an extended period of time (e.g., overnight), some or all of the surface of the membrane can adhere to adjacent surfaces, rendering the membrane valve partially or fully inoperable and requiring maintenance. In another example, pockets of liquid may get trapped between the membrane and adjacent surfaces when closed and therefore an insufficient volume of liquid may be dispensed therefrom. Accordingly, new approaches are needed for implementing membrane valves in a fluid delivery system of an in ovo injection apparatus.

Additionally, in a fluid delivery system, poor flow characteristics may create undesirable effects in the apparatus, including, for example, the accumulation of proteins from the drug along the fluid flow paths, which can lead to the growth of bacteria and reduced efficacy of the drug. In other examples, certain flow characteristics may create undesirable pressure gradients in the fluid as it passes through various chambers and/or pathways of the system, damaging and/or destroying living cells and/or other aspects of the fluid flowing therethrough. Accordingly, new approaches are needed for improving the flow characteristics in a fluid delivery system.

### SUMMARY

This Summary is provided to introduce a selection of concepts in a simplified form that are further described below in the Detailed Description section. This Summary is not intended to identify key features or essential features of the claimed subject matter, nor is it intended to be used to limit the scope of the claimed subject matter.

According to some aspects of the present invention, a fluid delivery system is provided that may include a plurality of pump assemblies. The plurality of pump assemblies may include a membrane pump and a plurality of membrane valves interconnected by fluid channels. The membrane pump and plurality of membrane valves may further include a diaphragm configured in open and closed positions for metering out and dispensing predetermined amounts of fluid treatment substance from a fluid reservoir fluidly connected to the pump assemblies via the fluid channels. The membrane pump and plurality of membrane valves may also include a pressure/vacuum chamber and a resilient membrane layer having a bottom side for at least partial contact with a first substrate of the pressure/vacuum chamber. The resilient membrane layer may also include a plurality of standoffs disposed on the bottom side configured for preventing total contact with the first substrate.

The standoffs may include a base end and a terminus end. The base end may be coupled to the resilient membrane layer bottom side and the standoffs may also be tapered from the base end to the terminus end such that the terminus end has a smaller cross-sectional area than the base end. The standoffs may also be substantially conical or semi-spherical.

The diaphragm of the fluid delivery system may include a fluid relief arrangement disposed on the bottom side of the resilient membrane layer. The fluid relief arrangement may be configured in a snowflake pattern. Further, the snowflake pattern may have three branches. Further still, the standoffs may be patterned between the three branches of the snowflake pattern.

The resilient membrane layer of the diaphragm may include a diaphragm portion encircled by a connecting portion. The connecting portion may have a thickness less than that of the diaphragm portion and may contact a second substrate of the pressure/vacuum chamber during the open condition thereby causing a consistent metered amount of dispensed fluid treatment substance. In some embodiments, the connecting portion may be tapered in thickness from less thick on an outer perimeter to more thick at a point where the connecting portion couples to the diaphragm portion. In certain other embodiments, the connecting portion may be substantially uniform in thickness, thereby resulting in a step between the connecting portion and the thicker diaphragm portion.

In some embodiments, the fluid channels may include optimized flow characteristics. The optimized flow characteristics may include radius bends and/or radius cross-sections within the fluid channels.

The fluid delivery system may also include inlet/outlet ports along the fluid channels that are tapered such that the fluid entering the port flows through an inlet having a diameter less than that of the outlet thereby minimizing the boundary layer and minimizing the pressure gradient from a center of the fluid flow to the outer edge of the fluid flow. In some embodiments, the inlet/outlet ports may also include a radius around the perimeter of the inlet.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a partial cross-sectional view of an in ovo injection delivery device capable of delivering a treatment substance into an avian egg;

FIG. 2 is a side view of an in ovo injection apparatus having a plurality of injection devices, wherein the in ovo injection apparatus comprises a fluid delivery system, according to one aspect of the present disclosure;

FIG. 3 is a plan view of a portion of the presently disclosed fluid delivery system and showing an example arrangement of pump assemblies comprising membrane valves, according to one aspect of the present disclosure;

FIG. 4 through FIG. 9 show cross-sectional side views of an example of the pump assembly and a process of dispensing a treatment substance therefrom, according to one aspect of the present disclosure;

FIG. 10A and FIG. 10B show cross-sectional side views of the diaphragm pump of the pump assemblies in the relaxed state and in the actuated state, respectively;

FIG. 11 is a perspective view of an example of the diaphragm of the diaphragm pump and showing certain features patterned thereon;

FIG. 12 is a plan view of the diaphragm pump that includes the diaphragm shown in FIG. 11;

FIG. 13 is a cross-sectional view of the diaphragm pump taken along Line A-A of FIG. 12;

FIG. 14 is a plan view and a side view of the diaphragm shown in FIG. 11 and showing more details of the standoffs and the fluid relief arrangement patterned thereon;

FIG. 15 is an expanded view of a Detail B of FIG. 14, showing more details of the fluid relief arrangement;

FIG. 16 is a cross-sectional view of a portion of the fluid relief arrangement of the diaphragm taken along Line E-E of FIG. 14;

FIG. 17 is an expanded view of a Detail F of the fluid relief arrangement of FIG. 15;

FIG. 18A, FIG. 18B, FIG. 18C, FIG. 19, and FIG. 20 show various views of an example of the input valve and/or the outlet valve of the pump assembly;

FIG. 21 is a plan view of a portion of one pump assembly and showing more details of the fluid paths therein, wherein the fluid paths have optimized flow characteristics;

FIG. 22 is a cross-sectional view of an example of a vertical flow path taken along Line A-A of FIG. 21;

FIG. 23 is a cutaway perspective view of a portion of one pump assembly and showing more details of the fluid paths therein;

FIG. 24 is a cross-sectional side view of an example of an inlet port of the pump assembly;

FIG. 25 and FIG. 26 are cross-sectional side views of yet other examples of an inlet/outlet of the pump assembly that have optimized flow characteristics; and

FIG. 27 is a plot of the diaphragm valve outlet flow path and showing an example of the flow velocity streamlines.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a fluid delivery system implemented within an in ovo injection apparatus, wherein the fluid delivery system comprises a plurality of membrane pumps/valves. In particular, the fluid delivery system includes a diaphragm pump/valve system that may be used to meter out a precise volume of, for example, a treatment substance liquid. Further, a diaphragm pump within the diaphragm pump/valve system may comprise certain standoff features on the surface thereof for reducing or entirely preventing adhesion of the diaphragm to adjacent surfaces when left idle for an extended period of time, as well as an arrangement of fluid relief channels in the surface thereof for reducing or entirely preventing the trapping of liquid between the diaphragm and adjacent surfaces.

Yet another aspect of the presently disclosed diaphragm valve comprises a fluid relief arrangement, wherein the arrangement includes a plurality of fluid channels arranged in, for example, a snowflake-like pattern.

Yet another aspect of the presently disclosed diaphragm valve is that the fluid relief arrangement thereof is used for reducing or entirely preventing the trapping of liquid between the diaphragm and adjacent surfaces.

Still another aspect of the presently disclosed diaphragm valve is that the fluid relief arrangement thereof can also assist to reduce or entirely prevent the adhesion of the diaphragm to adjacent surfaces when left idle for an extended period of time.

Further still, another aspect of the presently disclosed diaphragm valve is that the amount of diaphragm deflection and the geometry of the deflection is substantially the same from one actuation to the next, thereby ensuring reliability and repeatability with respect to dispensing a precise volume of the treatment substance fluid.

An exemplary in ovo processing system that may be utilized to inject a substance, particularly substances such as oil-based and aqueous-based treatment substances, into eggs in accordance with aspects of the present disclosure, is the system known as INOVOJECT® egg injection apparatus, manufactured by Embrex, Inc. (Durham, N.C.). However, embodiments of the present invention may be utilized with any in ovo processing device.

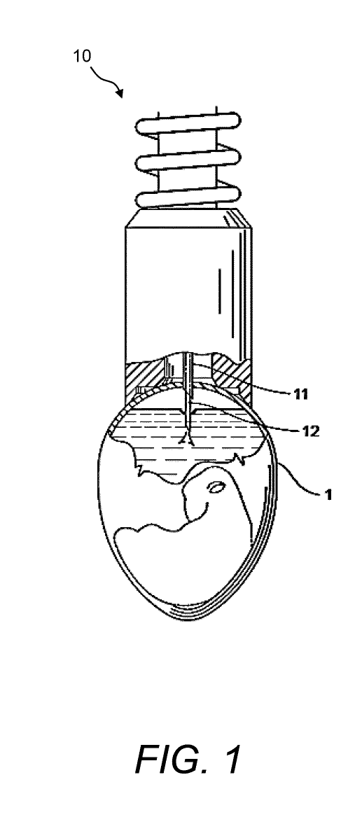

Referring now to FIG. 1, a partial cross-sectional view of an in ovo injection delivery device 10 that is capable of delivering a treatment substance into an avian egg is depicted. In this example, in ovo injection delivery device 10 is the in ovo injection delivery device of the Embrex INOVOJECT® egg injection apparatus. The injection delivery device 10 includes a punch 11 configured to form an opening in the shell of an egg 1. An injection needle 12 may be movably disposed within the punch 11 (i.e., the punch 11 may substantially concentrically surround the respective injection needle 12) so that after the punch 11 makes an opening in the shell of an egg, the injection needle 12 may move through the punch 11 and respective opening of an egg shell to an injecting position(s) within an egg for delivery of one or more substances therein. However, various types of injection delivery devices may be utilized in accordance with aspects of the present disclosure. Aspects of the present disclosure are not limited to the illustrated injection delivery device.

After injection of one or more treatment substances into an egg via the injection delivery device 10 of FIG. 1, or the removal of material from the egg, portions of the punch 11 and needle 12 may be treated with a sanitizing fluid, for example, via spraying, dipping, and/or allowing sanitizing fluid to flow through the needle and/or punch, and the like.

As used herein, the term “treatment substance” may refer to a substance that is injected into an egg to achieve a desired result. Similarly, dosing or dosage may refer to one unit of a treatment substance, meaning one unit of a treatment substance for a respective egg. Treatment substances may include, but are not limited to, vaccines, antibiotics, vitamins, virus, and immunomodulatory substances. Treatment substances may also include certain vaccines designed for in ovo use to combat outbreaks of avian diseases in the hatched birds that may be produced by the user and/or commercially available. In some embodiments, the treatment substance is dispersed in a fluid medium, e.g., a fluid or emulsion, or is a solid dissolved in a fluid, or a particulate dispersed or suspended in a fluid.

As used herein, the term “needle” or “injection needle” may refer to an instrument designed to be inserted into an egg to deliver a treatment substance into the interior of the egg. The term “needle” or “injection needle” may also refer to an instrument designed to be inserted into an egg to remove material therefrom. A number of suitable needle designs will be apparent to those skilled in the art. The term “injection tool” as used herein may refer to a device designed to both pierce the shell of an avian egg and inject a treatment substance therein and/or remove material therefrom. Injection tools may comprise a punch for making a hole in the egg shell, and an injection needle that is inserted through the hole made by the punch to inject a treatment substance in ovo. Various designs of injection tools, punches, and injection needles will be apparent to those in the art.

As used herein, “in ovo injection” may refer to the placing of a substance within an egg prior to hatch. The substance may be placed within an extraembryonic compartment of the egg (e.g., yolk sac, amnion, allantois) or within the embryo itself. The site into which injection is achieved will vary depending on the substance injected and the outcome desired, as will be apparent to those skilled in the art.

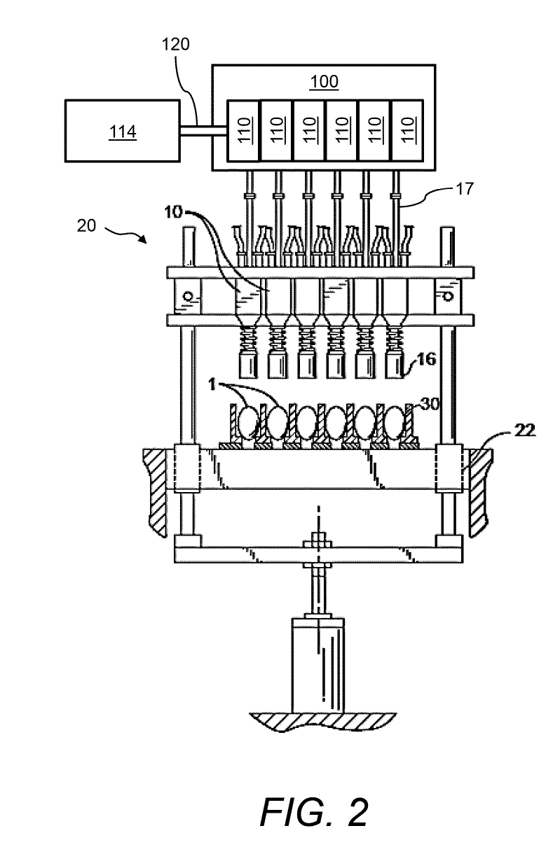

Referring now to FIG. 2, a side view of an in ovo injection apparatus 20 comprising a plurality of the injection delivery devices 10 shown in FIG. 1 is shown. The injection apparatus 20 may be fluidly coupled to a fluid delivery system 100, according to one aspect of the present disclosure.

The injection delivery devices 10 of the injection apparatus 20 may be configured to inject one or more substances in multiple eggs according to aspects of the present disclosure. The injection apparatus 20 may include a stationary base 22 in relation to the plurality of injection delivery devices 10.

A flat 30 holds a plurality of eggs 1 in a substantially upright position. The flat 30 may be configured to provide external access to predetermined areas of the eggs 1. Each egg 1 may be held by the flat 30 so that a respective end thereof is in proper alignment relative to a corresponding one of the injection delivery devices 10 as the injection delivery device 10 advances towards the base 22 of the apparatus. However, in ovo injection devices may inject eggs oriented in various orientations. Aspects of the present disclosure are not limited only to in ovo injection devices that inject eggs in the illustrated orientation.

Each of the plurality of injection delivery devices 10 may have opposing first and second ends 16 and 17, respectively. The injection delivery devices 10 may have a first extended position and a second retracted position. Upon extension of an injection delivery device 10, the first end 16 may be configured to contact and rest against predetermined areas of an external egg shell. From this position, a punch 11 (see FIG. 1) within the injection delivery device 10 may form a small opening in the shell, thereby allowing the injection needle 12 (see FIG. 1) to be inserted therethrough to deliver one or more substances into the egg 1 and/or remove materials therefrom. When not injecting, the injection delivery devices 10 may be retracted to rest at a predetermined distance above the eggs 1 and stationary base 22. Alternatively, the base 22 can be longitudinally slidably moveable (e.g., a conveyor) to position the eggs 1 in proper position relative to the injection delivery devices 10.

Each injection delivery device 10 may be configured to deliver discrete amounts of a treatment substance. Namely, the fluid delivery system 100 may supply a treatment substance to the injection delivery devices 10. The fluid delivery system 100 may include a plurality of pump assemblies 110. For example, one pump assembly 110 for each of the injection delivery devices 10 (e.g., twelve pump assemblies 110 for twelve injection delivery devices 10). The upstream sides of the pump assemblies 110 may be fluidly coupled to a fluid reservoir 114 via a fluid channel 120. The downstream sides of the pump assemblies 110 may be fluidly coupled to the second end 17 of each of the injection delivery devices 10. The pump assemblies 110 in the fluid delivery system 100 may be arranged in a manifold in fluid communication with the fluid reservoir 114. The pump assemblies 110 may be used to pump the treatment substance from the fluid reservoir 114 through the injection delivery devices 10.

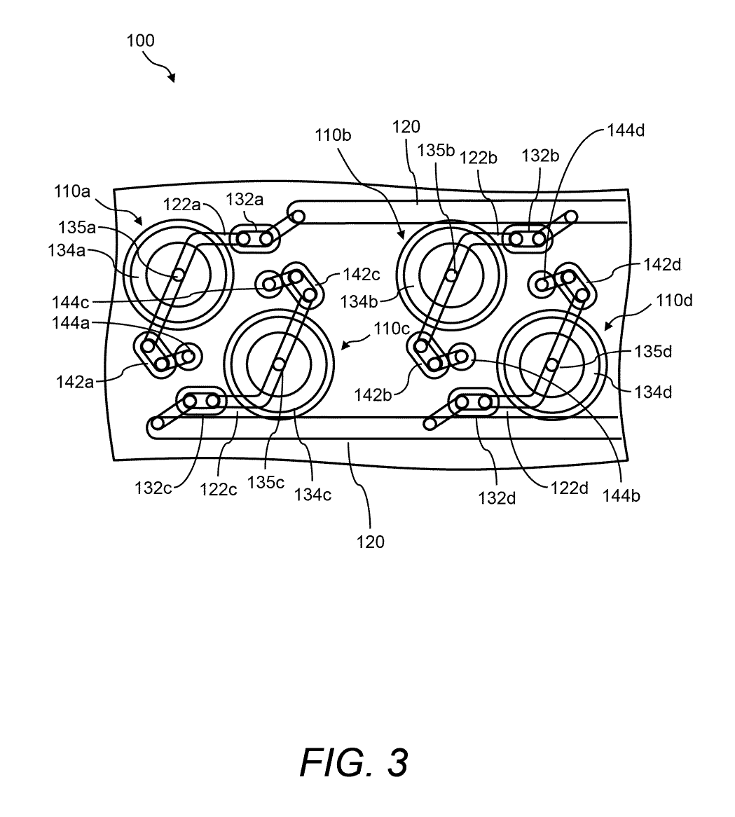

Embodiments of the present invention are not limited to the illustrated configurations of a single fluid delivery system 100. For example, more than one fluid reservoir 114 may be utilized for each injection apparatus 20. In this regard, a plurality of fluid delivery systems 100 may be implemented to provide more than one treatment substances. In some instances, each pump assembly 110 may be used to deliver more than one treatment substance to the injection delivery devices 10. More details of an example of the pump assemblies 110 are shown and described hereinbelow with reference to FIG. 3 through FIG. 10.

Referring now to FIG. 3, a plan view of a portion of the presently disclosed fluid delivery system 100 is shown, illustrating an example arrangement of pump assemblies 110 comprising membrane valves and pumps, according to one aspect of the present disclosure. By way of example, FIG. 3 shows four pump assemblies 110 (e.g., pump assemblies 110a, 110b, 110c, 110d).

The pump assemblies 110 may be advantageously used with the injection delivery devices 10. Each pump assembly 110 may include a fluid channel 122 that interconnects a set of membrane valves/pumps. For example, in pump assembly 110, the fluid channel 122 may interconnect, in order, an input valve 132, a diaphragm pump 134, and an outlet valve 142.

In each pump assembly 110, the input valve 132 may be used to fluidly couple the fluid channel 120 from the fluid reservoir 114 to a first end of the fluid channel 122. In this way, the fluid reservoir 114 may supply the pump assembly 110. An outlet port 144 may be provided at a second end of the fluid channel 122 of the pump assembly 110, wherein the input valve 132, the diaphragm pump 134, and the outlet valve 142 may be arranged between the first and second ends of the fluid channel 122. The outlet port 144 of each pump assembly 110 may be fluidly coupled to the second end 17 of one of the injection delivery devices 10. The pump assembly 110 may be optimally configured for pumping fluids, such as one or more fluids for injection into eggs as provided herein.

In some embodiments, the fluid path for each pump assembly 110 is as follows. The fluid channel 120 supplies an inlet of the input valve 132. An outlet of the input valve 132 supplies an inlet/outlet 135 of the diaphragm pump 134 via the fluid channel 122. The inlet/outlet 135 of the diaphragm pump 134 supplies an inlet of the outlet valve 142 via the fluid channel 122. An outlet of the outlet valve 142 supplies the outlet port 144 via the fluid channel 122.

In each pump assembly 110, the diaphragm pump 134 is typically, though not necessarily, the larger of the valves/pumps. Namely, the diaphragm pump 134 is used to meter out a precise volume of treatment substance. Accordingly, the size of the diaphragm pump 134 is designed for metering out a selected precise volume of treatment substance. In some embodiments, the diaphragm pump 134 is configured to dispense a selected precise volume of treatment substance accurate to within ±5%. In one example, the diaphragm pump 134 is designed to accurately dispense a dose of about 50 μl of treatment substance. Various other dosage volumes, both greater than and less than the about 50 μl example, are also envisioned. In some embodiments, dosages may be accurately measured by the diaphragm pump 134 to within ±10%.

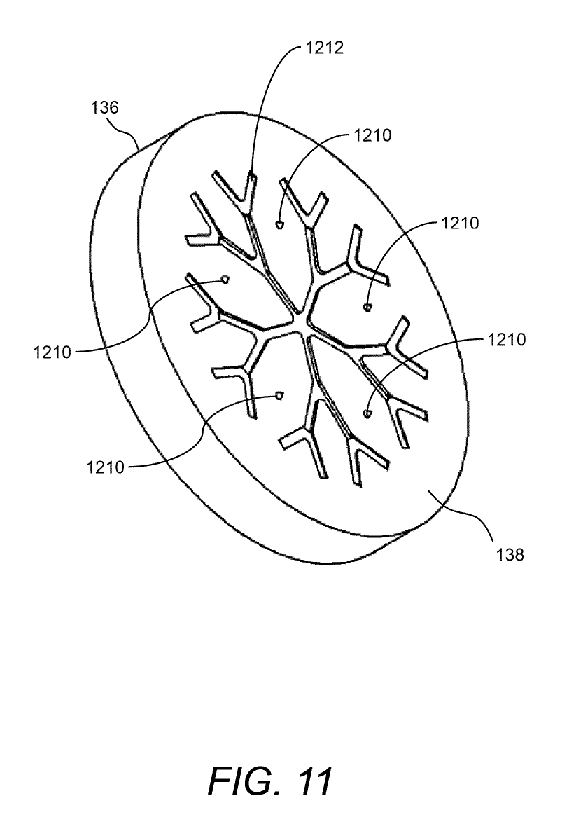

Further, the diaphragm pump 134 may comprise certain features for reducing or entirely preventing the adhesion of the diaphragm to adjacent surfaces. Such adhesion is possible when, for example, the system is left idle for an extended period of time (e.g. overnight). Other features configured to reduce or entirely prevent the trapping of liquid between the diaphragm and adjacent surfaces may be included as well. Certain embodiments of these features are shown and described hereinbelow with reference to FIG. 11 through FIG. 27.

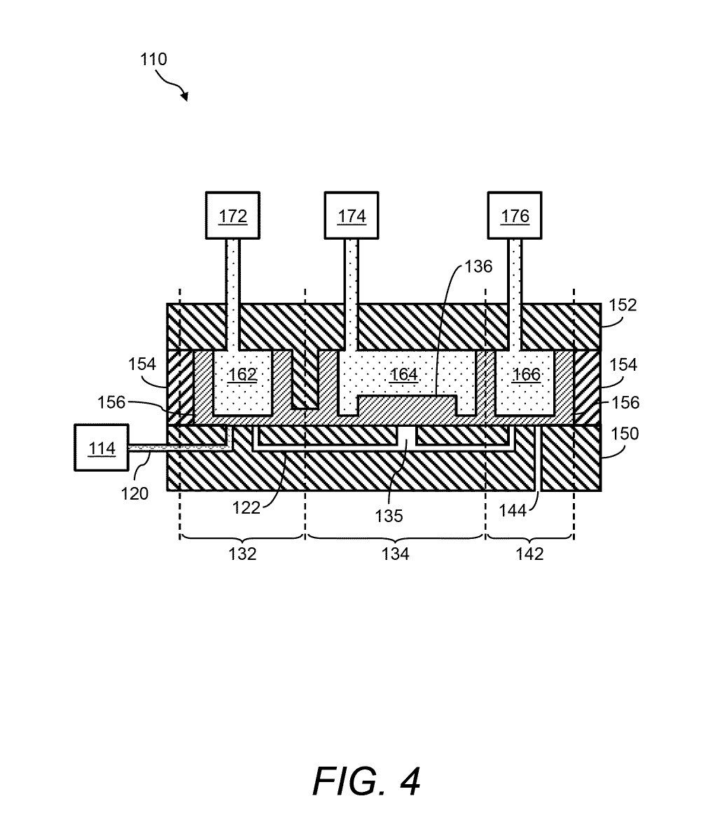

Referring now to FIG. 4 through FIG. 9, cross-sectional side views of an example of the pump assembly 110 and a process of dispensing a treatment substance therefrom, according to one aspect of the present disclosure, are illustrated. The pump assembly 110 may include a first panel (or substrate) 150 and a second panel (or substrate) 152 that are held a certain distance apart via, for example, one or more spacers 154, thereby defining a chamber therebetween. The first panel 150, the second panel 152, and the spacers 154 may be formed, for example, of a metal, polymer, composite or similar material.

The first panel 150 may define the fluid channel 122 therein. The fluid channel 122 may be configured as illustrated, or may take on any other appropriate configurations. The fluid channel 122 may be configured to receive a fluid treatment substance from the fluid reservoir 114, wherein the fluid reservoir 114 is coupled to the first panel 150 via the fluid channel 120. The fluid reservoir 114 may supply, for example, treatment substance fluids 180 to be injected into an egg.

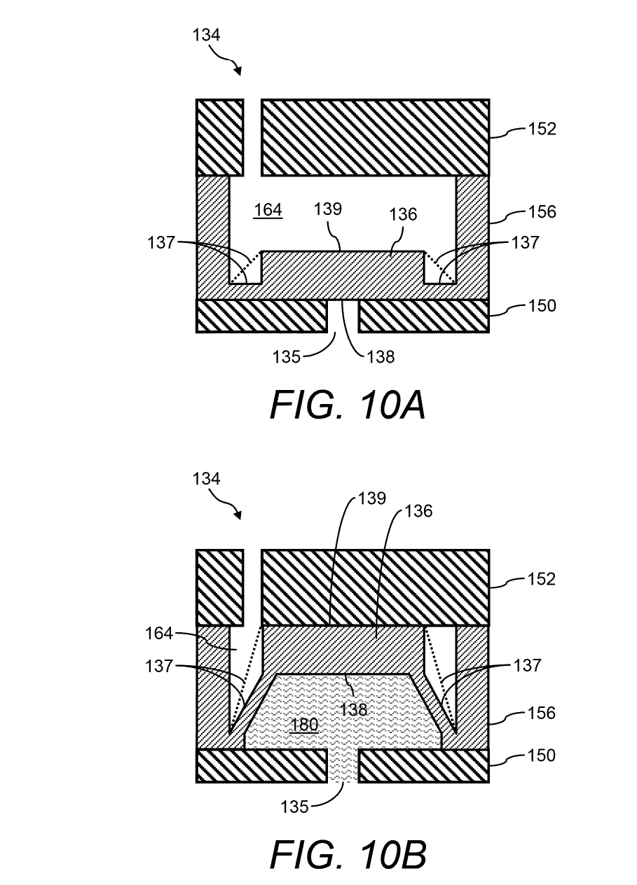

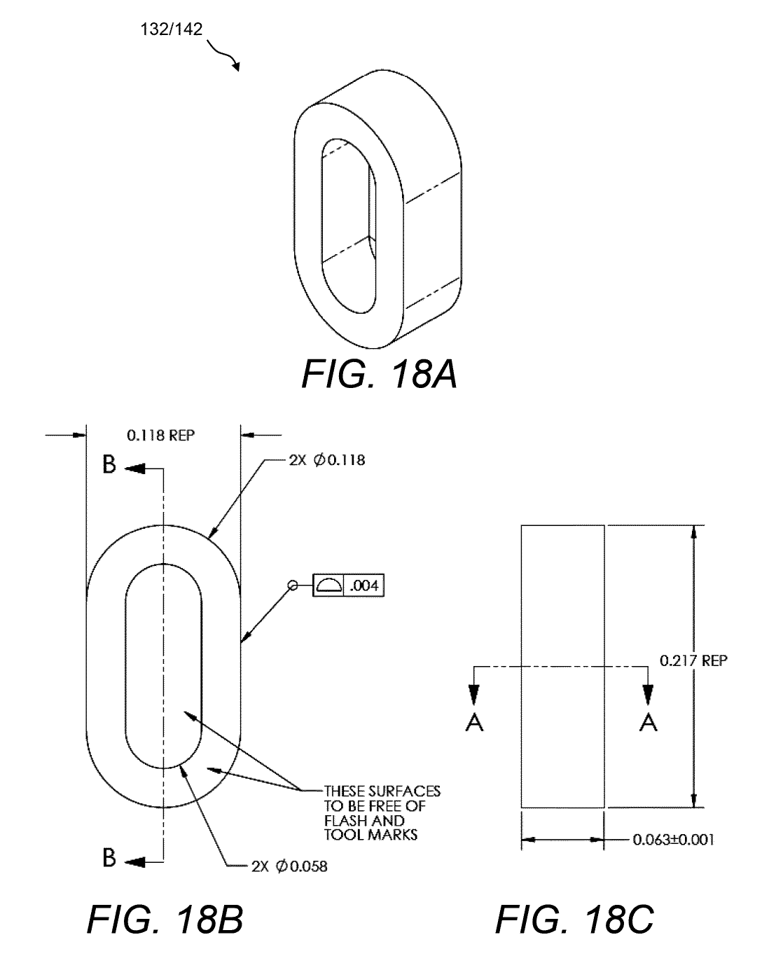

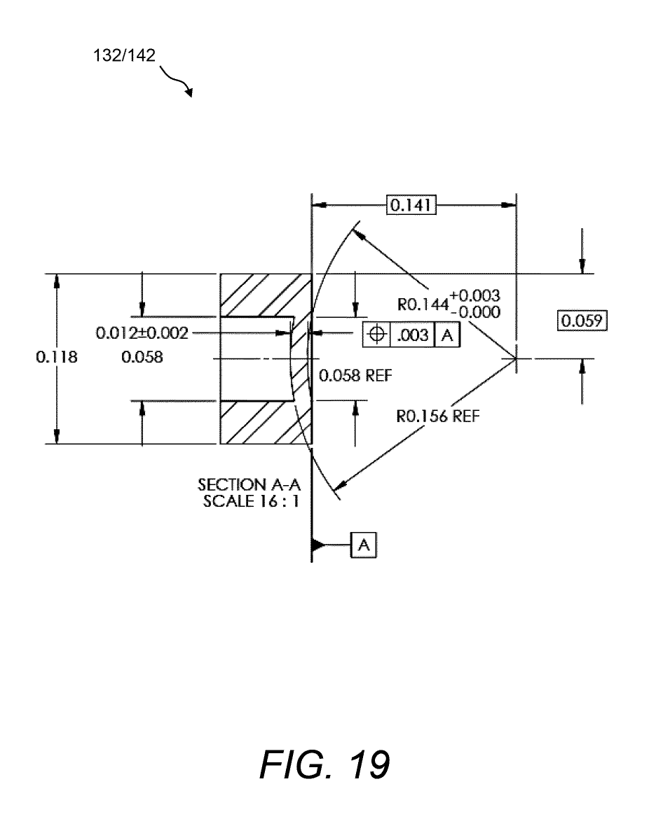

A resilient membrane layer 156 may be provided in the chamber between the first panel 150 and the second panel 152. The resilient membrane layer 156 is typically flexible and/or stretchable. The resilient membrane layer 156 can be, for example, a silicone elastomer material or a fluoroelastomer material, such as the Dyneon™ brand fluoropolymers. The resilient membrane layer 156 may also be any other suitable material. In some embodiments, the resilient membrane layer 156 defines the input valve 132, the diaphragm pump 134, and the outlet valve 142. Further, using resilient membrane layer 156, the diaphragm pump 134 may be sized for metering out a precise amount of the treatment substance fluid 180 to be injected into an egg (not shown). More particularly, the diaphragm pump 134 may include a diaphragm 136 (formed in the resilient membrane layer 156) whose size and amount of deflection may be specifically designed for metering out a precise amount of the treatment substance fluid 180 (e.g. about 50 μl). More details of an example of the diaphragm 136 and the diaphragm pump 134 are shown and described hereinbelow with reference to FIG. 10A through FIG. 17. Further, more details of an example of the input valve 132, and the outlet valve 142 are shown and described hereinbelow with reference to FIG. 18A through FIG. 22.

The resilient membrane layer 156 is illustrated as a one-piece unit in which each of the input valve 132, the diaphragm pump 134, and the outlet valve 142 are interconnected, while, in other embodiments, one or more respective portions may be disjointed. Further, the inlet/outlet 135 of the diaphragm pump 134 is defined in the first panel 150. Additionally, the outlet port 144 of the outlet valve 142 is defined in the first panel 150. The inlet/outlet 135 of the diaphragm valve 134 and/or the outlet port 144 of the outlet valve 142 may, alternatively, be independent of the first panel 150.

In some embodiments, the resilient membrane layer 156 serves as the elastic membrane for opening and closing the membrane valves/pumps; in particular, for opening and closing the input valve 132, the diaphragm pump 134, and the outlet valve 142. Namely, the resilient membrane layer 156 may be in communication with the fluid channel 122 defined in the first panel 150 for directing flow of fluid therethrough. The resilient membrane layer 156 may also be configured for allowing selective flow-through of fluid through the fluid channel 122 per the input valve 132, the diaphragm pump 134, and the outlet valve 142.

The resilient membrane layer 156 may be configured to provide discrete pressure/vacuum chambers for controlling the flow-through of fluid through the input valve 132, the diaphragm pump 134, and the outlet valve 142. For example, a pressure/vacuum chamber 162 is provided to control the input valve 132, a pressure/vacuum chamber 164 is provided to control the diaphragm pump 134, and a pressure/vacuum chamber 166 is provided to control the outlet valve 142.

The second panel 152 may be configured for supplying a pressure/vacuum source to each of the input valve 132, the diaphragm pump 134, and the outlet valve 142. For example, a pressure/vacuum source 172 may supply the pressure/vacuum chamber 162 of the input valve 132. A pressure/vacuum source 174 may supply the pressure/vacuum chamber 164 of the diaphragm pump 134. A pressure/vacuum source 176 may supply the pressure/vacuum chamber 166 of the outlet valve 142. The pressure/vacuum sources 172, 174, 176 may be individually controlled and may be any of a desired pressure/vacuum source, including a high, low, or vacuum pressure. For example, the pressure/vacuum sources 172, 174, 176 may be capable of providing from about 30 psi to about 300 psi. With respect to vacuum pressure, the pressure/vacuum sources 172, 174, 176 may be capable of providing a vacuum from about 300 millibars to about 950 millibars in one example, or from about 600 millibars to about 700 millibars in another example. In certain other embodiments, however, the pressure/vacuum sources may be capable of supplying greater or lower pressures.

In some embodiments, the pressure/vacuum sources 172, 174, 176 are the mechanisms for actuating the input valve 132, the diaphragm pump 134, and the outlet valve 142. “Actuating” or “actuation” means deflecting the resilient membrane layer 156 to open and/or close the input valve 132, the diaphragm pump 134, and/or the outlet valve 142.

In operation, using the select valve 130 as an example, when pressure source 170 provides a positive pressure, the resilient membrane layer 156 of the select valve 130 may be pushed by pressure against the surface of the first panel 150, thereby blocking the flow of liquid through the inlet and outlet thereof. In so doing, the select valve 130 is closed. By contrast, when pressure source 170 provides a vacuum pressure, the resilient membrane layer 156 of the select valve 130 may be deflected away from the surface of the first panel 150 (i.e., toward the second panel 152). Accordingly, a void or space may be created between the resilient membrane layer 156 and the surface of the first panel 150 through which liquid may flow. In some embodiments, the liquid may be treatment substance fluid 180. In so doing, the select valve 130 is opened. The input valve 132, the diaphragm valve 134, and the outlet valve 142 operate in like manner.

Referring now again to FIG. 4 through FIG. 10, the process of dispensing a treatment substance fluid 180 from the pump assembly 110 is summarized as follows. Referring now to FIG. 4, using the respective pressure/vacuum sources 172, 174, 176, the input valve 132 is closed, the diaphragm pump 134 is closed, and the outlet valve 142 is closed. In so doing, no treatment substance fluid 180 is allowed to flow from the fluid reservoir 114 into the pump assembly 110.

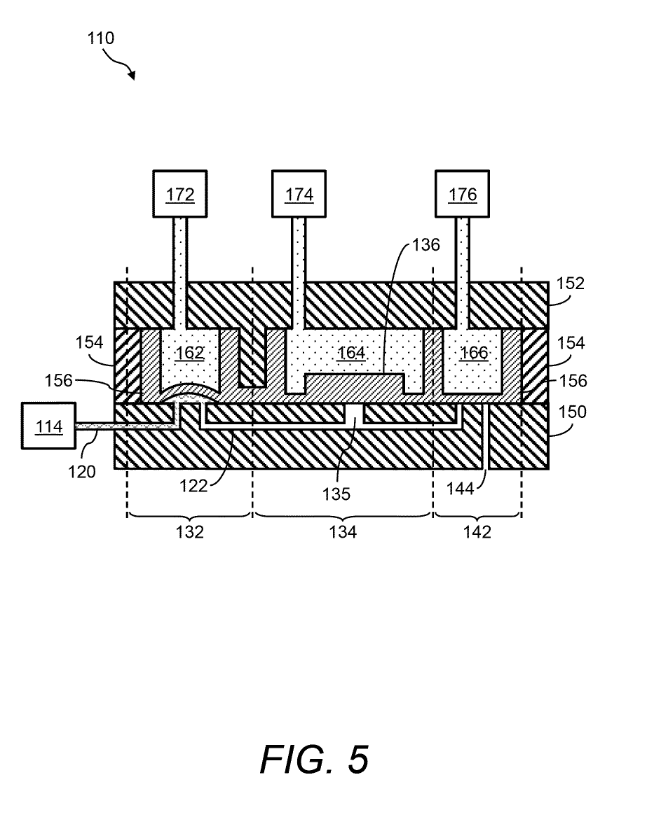

Referring now to FIG. 5, using the respective pressure sources 172, 174, 176, the input valve 132 is opened, the diaphragm pump 134 is closed, and the outlet valve 142 is closed. In so doing, the input valve 132 is prepared to receive the treatment substance fluid 180.

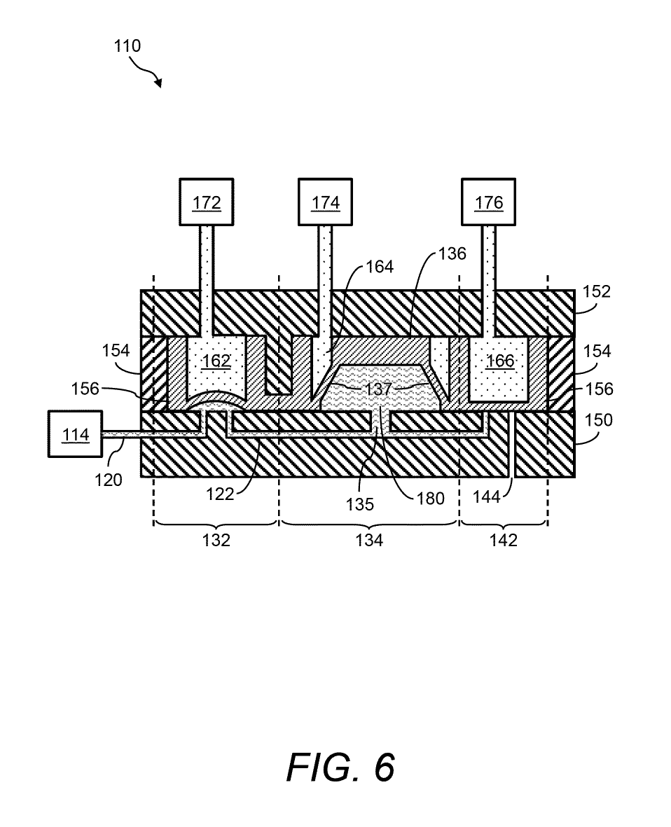

Referring now to FIG. 6, using the respective pressure sources 172, 174, 176, the input valve 132 is opened, the diaphragm pump 134 is opened, and the outlet valve 142 is closed. In so doing, the treatment substance fluid 180 may flow from the fluid reservoir 114 and into the input valve 132 and the diaphragm pump 134, but not into the outlet valve 142. Namely, in this step a precise amount of the treatment substance fluid 180 may be drawn into the diaphragm pump 134.

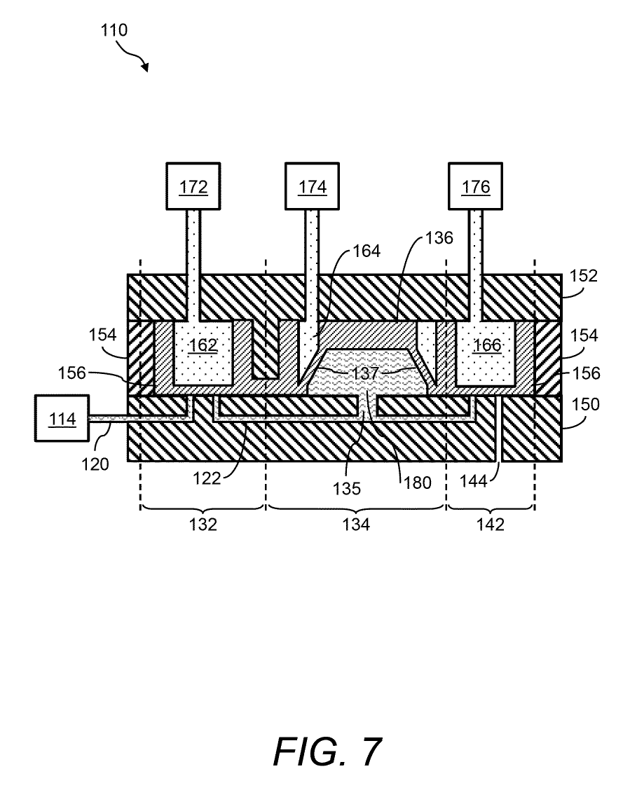

Referring now to FIG. 7, using the respective pressure sources 172, 174, 176, the input valve 132 is closed, the diaphragm pump 134 is opened, and the outlet valve 142 is closed. In so doing, a precise amount of the treatment substance fluid 180 is staged in the diaphragm pump 134 in preparation for, in some embodiments, dispensing and injecting treatment fluid 180 into an egg (not shown).

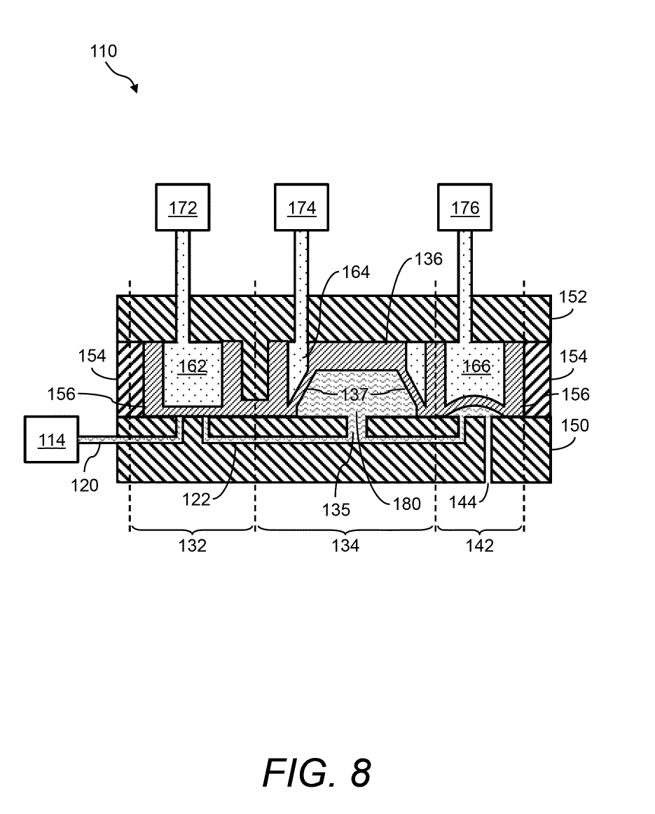

Referring now to FIG. 8, using the respective pressure sources 172, 174, 176, the input valve 132 is closed, the diaphragm pump 134 is opened, and the outlet valve 142 is opened in preparation for dispensing the treatment substance fluid 180 from the pump assembly 110.

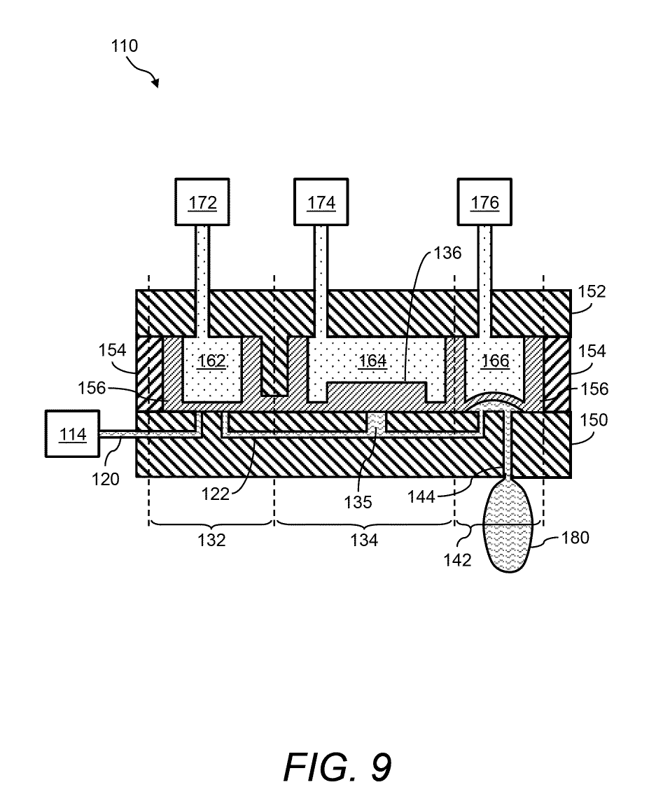

Referring now to FIG. 9, using the respective pressure sources 172, 174, 176, the input valve 132 is closed, the diaphragm pump 134 is closed, and the outlet valve 142 is opened. In so doing, a precise amount of the treatment substance fluid 180 is pushed out of the diaphragm valve 134, through the outlet valve 142 and out of the outlet port 144, as shown.

Note further that in some embodiments, a separate select valve may be employed. Operation of the system with this additional select valve is described, for example, in further detail in U.S. Publication No. 2014/0014040 titled Fluid Delivery System, and Associated Apparatus and Method, the disclosure of which is hereby incorporated by reference in its entirety.

Again, the diaphragm 136 of the diaphragm pump 134 may be designed for metering out a precise amount of the treatment substance fluid 180. Referring now to FIG. 10A and FIG. 10B, cross-sectional side views of the diaphragm pump 134 of the pump assemblies 110 are illustrated in both a relaxed state and in an actuated state, respectively. The resilient membrane layer 156 includes a connecting portion 137 around the perimeter of the diaphragm 136. In some embodiments, the thickness of the diaphragm 136 is greater than the thickness of the connecting portion 137. Accordingly, there may be a “step” in the topology of the diaphragm pump 134 and the connecting portion 137. In certain other embodiments, the connecting portion 137 may be tapered such into the diaphragm 136 creating a smooth transition rather than a “step.”

The diaphragm 136 may have a first surface 138 that is facing the first panel 150 and a second surface 139 facing the second panel 152. Referring now to FIG. 10A, when no pressure or a positive pressure is applied to the pressure/vacuum chamber 164, the diaphragm pump 134 may be closed because the diaphragm 136 is relaxed against the first panel 150. Namely, the first surface 138 of the diaphragm 136 is in contact with the surface of the first panel 150, thereby substantially blocking the flow of fluid into diaphragm pump 134 through the inlet/outlet 135.

In certain other embodiments, the relaxed state of the diaphragm 136 may be in an open position such that when no pressure is applied to the pressure/vacuum chamber 164, the diaphragm pump 134 may be in the open state. Configuring the diaphragm 136 for this open position may also be facilitated by applying a vacuum in the pressure/vacuum chamber. In this embodiment, positive pressure in the pressure/vacuum chamber may be required to move the diaphragm to closed position.

When the input valve 132 and the outlet valve 142 are actuated or opened (see FIG. 5 and FIG. 9), their deflection may be generally in a dome shape in free space. Using this type of deflection, the amount of defection and the geometry of the deflection can vary slightly from one actuation to the next. Accordingly, it not desirable to use this dome-shaped deflection in free space for the diaphragm pump 134, which is designed to dispense a precise amount of the treatment substance fluid 180. Instead, the diaphragm pump 134 is designed to provide a repeatable and reliable deflection when actuated. Referring now to FIG. 10B, when vacuum pressure is applied to the pressure/vacuum chamber 164, the diaphragm pump 134 is opened because the diaphragm 136 is pulled away from the first panel 150 and toward the second panel 152. In this state, liquid can be drawn through the inlet/outlet 135 and fill the space or void between the diaphragm 136 and the first panel 150. In some embodiments, the second surface 139 of the diaphragm 136 is pulled into contact with the surface of the second panel 152. The diaphragm 136 is allowed to pull flat against the second panel 152 without deflection because of the thinner connecting portion 137 that stretches. Because the diaphragm 136 is pulled flat against the surface of the second panel 152, the amount of defection and the geometry of the deflection is substantially the same from one actuation to the next, thereby ensuring reliability and repeatability with respect to dispensing the desired precise volume of the treatment substance fluid 180. In one example, the diaphragm pump 134 that comprises the diaphragm 136 is designed for reliability and repeatability dispensing about 50 μl±5% of the treatment substance fluid 180.

In certain other embodiments, however, the diaphragm 136 is pulled away from the first panel 150 and toward the second panel 152, but stops short of contacting the second panel 152. In these embodiments, the connecting portion may be configured such that reliable and repeatable measurements of fluids may be measured and/or dispensed without the need for the diaphragm 136 to contact the second panel 152. In such embodiments, the diaphragm 136 may be configured to remain substantially flat (e.g. by manufacturing diaphragm 136 with thicker material or altogether different material relative to the connecting portion 137) or alternatively, may be configured to be tapered such that certain parts of the diaphragm 136 are thicker than others.

Further, the larger the area of the diaphragm 136 that comes into contact with the first panel 150, the higher the risk of adhering or sticking to the first panel 150 when left idle for an extended period of time (e.g., overnight). Accordingly, certain features may be designed into the first surface 138 of the diaphragm 136 for reducing or entirely preventing the adhesion of the diaphragm 136 to the first panel 150.

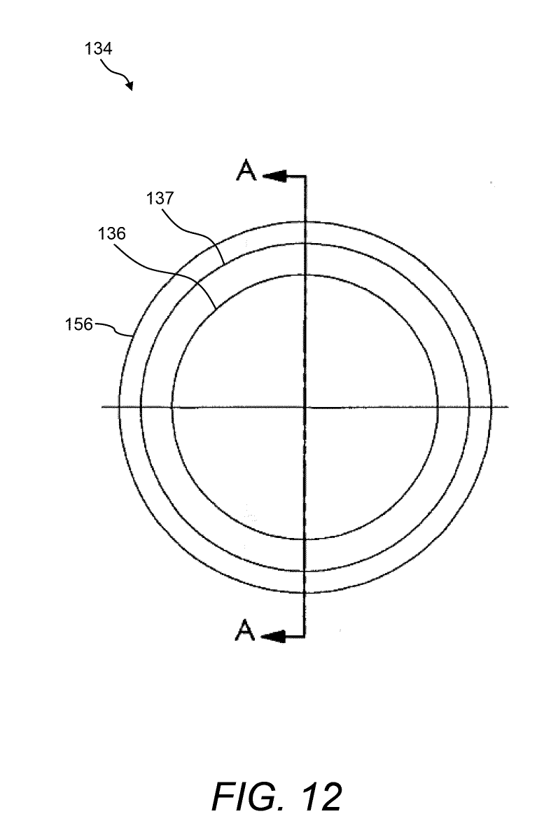

Additionally, the larger the area of the diaphragm 136 that comes into contact with the first panel 150, the higher the risk of liquid being trapped between the first surface 138 of the diaphragm 136 and the surface of the first panel 150 instead of being pushed out of the inlet/outlet 135, thereby potentially resulting in an insufficient volume of fluid (e.g. the treatment substance fluid 180) being dispensed. Accordingly, certain features may be designed into the first surface 138 of the diaphragm 136 for reducing or entirely preventing the trapping of liquid between the diaphragm 136 and the first panel 150. More details of an example of the diaphragm 136 that includes features for preventing the adhesion of the diaphragm 136 to the first panel 150 and features for preventing the trapping of fluid between the diaphragm 136 and the first panel 150 are shown and described herein below with reference to FIG. 12 through FIG. 18.

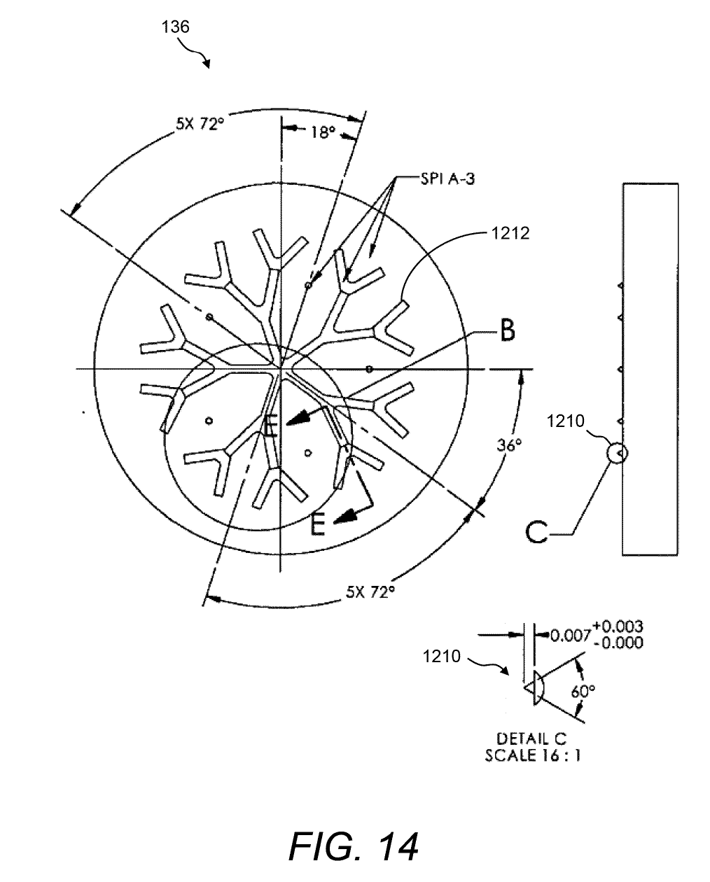

Referring now to FIG. 11, a perspective view of an example of the diaphragm 136 of the diaphragm pump 134 is depicted showing certain features patterned thereon. Note that for the purposes of illustrating the features for preventing the adhesion of the diaphragm 136 to the first panel 150 and features for preventing the trapping of fluid between the diaphragm 136 and the first panel 150, the features may also extend from the diaphragm 136 to the connecting portion 137 discussed previously. In some embodiments, a plurality of standoffs 1210 may be provided on the first surface 138 of the diaphragm 136 (and/or the connecting portion 137). The standoffs 1210 are features that are designed to prevent the adhesion of the first surface 138 of the diaphragm 136 to the first panel 150 by preventing the entirety of the first surface 138 from making contact with the first panel 150 while at the same time not interfering with the operation of the diaphragm pump 134. In some embodiments, the plurality of standoffs 1210 may be generally conical in shape, thereby further minimizing the surface area of the first surface 138 of the diaphragm 136 (and/or the connecting portion 137) in contact with the first panel 150. The conical shape may also aid in the manufacturing process. Additionally, a conical configuration may also minimize the potential for manufacturing variances in the volume displaced by the standoffs 1210 when fluid is brought into diaphragm pump 134. An exemplary detail of one standoff according to aspects of the present disclosure is shown in FIG. 14. While the standoff shown herein is conical in shape, it is understood that the standoff may be cylindrical, semi-spherical, or any other protrusion shape. The plurality of standoffs 1210 may be distributed on the first surface 138 of the diaphragm 136 in any manner desirable, including, for example, randomly dispersed, dispersed according to a pattern, or the like.

Further, in some embodiments a fluid relief arrangement 1212 may be provided on the first surface 138 (and/or the connecting portion 137) of the diaphragm pump 134. The fluid relief arrangement 1212 includes a plurality of fluid channels arranged in, for example, a snowflake-like pattern. Those skilled in the art will appreciate, however, that other patterns may also be employed. In this example, the snowflake pattern has three tiers of branching, but certain other embodiments could have increased or decreased tiers of branching. In accordance with the discussion above, the standoffs 1210 may be positioned in the spaces between the branches of the fluid relief arrangement 1212.

The fluid relief arrangement 1212 is designed to prevent the trapping of liquid between the diaphragm 136 and the first panel 150 while at the same time not interfering with the operation of the diaphragm pump 134. Namely, when the diaphragm pump 134 is closed and the first surface 138 of the diaphragm 136 is flat against the surface of the first panel 150, the fluid relief arrangement 1212 may provide flow paths toward the inlet/outlet 135, whereas the center of the snowflake pattern of the fluid relief arrangement 1212 substantially aligns with the inlet/outlet 135.

A further benefit of the fluid relief arrangement 1212 is that it may also help prevent the adhesion of the first surface 138 of the diaphragm 136 to the first panel 150. Namely, the presence of the fluid relief arrangement 1212 reduces the amount of surface area in contact with the first panel 150. Accordingly, in some embodiments, the diaphragm 136 may include the standoffs 1210 only, while the fluid relief arrangement 1212 is omitted. In certain another embodiments, the diaphragm 136 may include the fluid relief arrangement 1212 only, while the standoffs 1210 are omitted.

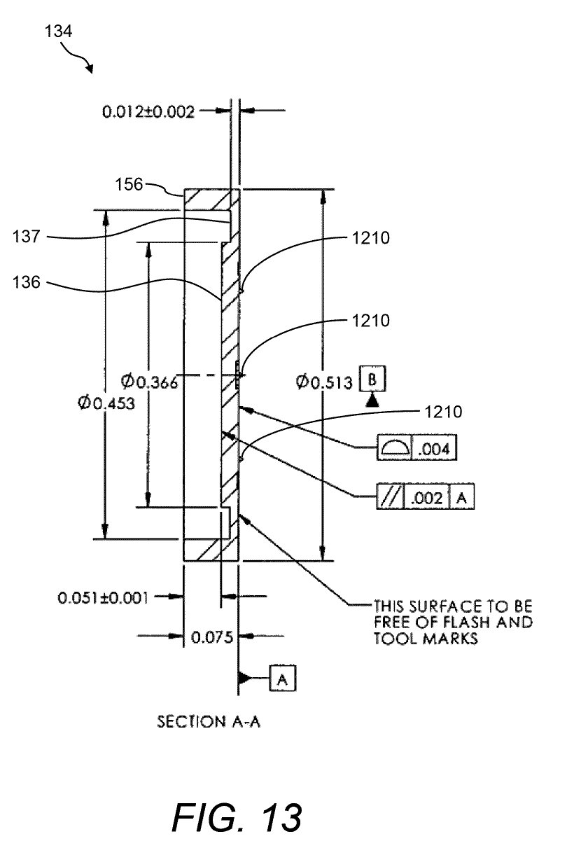

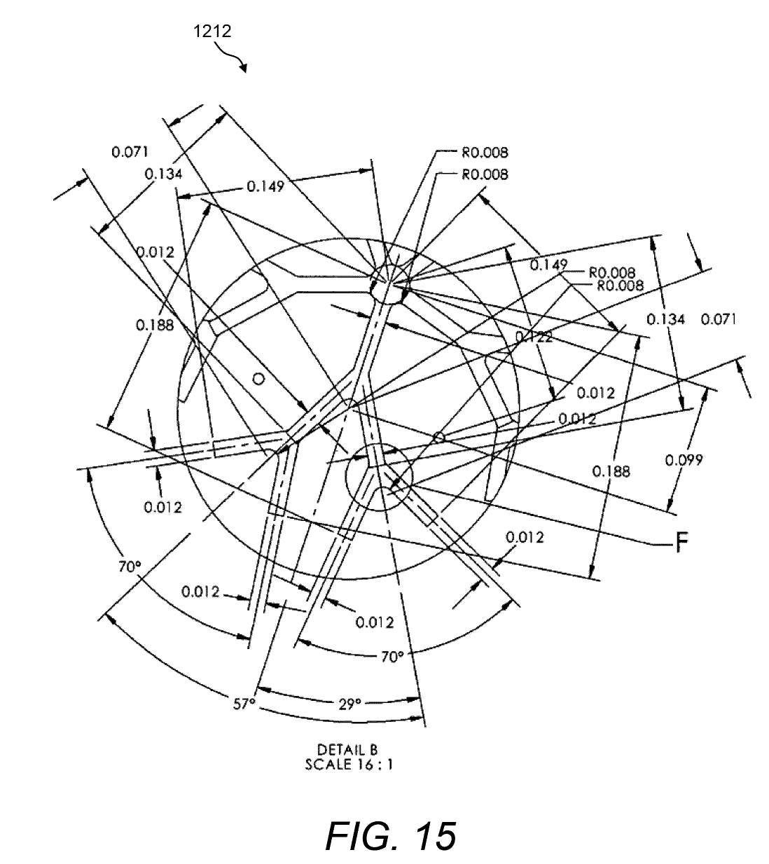

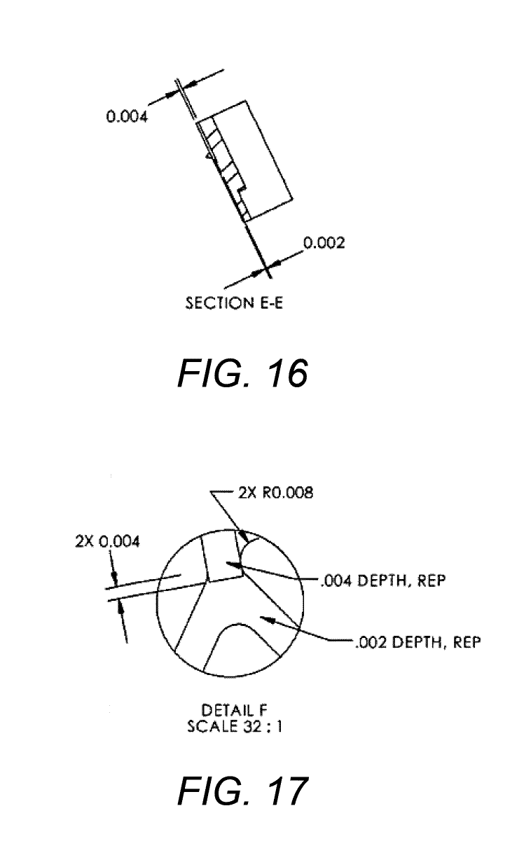

Referring now to FIG. 12, FIG. 13, FIG. 14, FIG. 15, FIG. 16, and FIG. 17, various views showing more details of the diaphragm 136 and the diaphragm pump 134 are presented. Namely, FIG. 12 is a plan view of the diaphragm pump 134 that includes the diaphragm 136 shown in FIG. 11, according to some embodiments of the disclosure. FIG. 13 is a cross-sectional view of the diaphragm pump 134 taken along Line A-A of FIG. 12, according to some embodiments of the disclosure. FIG. 14 is a plan view and a side view of the diaphragm 136 shown in FIG. 11 and showing more details of the standoffs 1210 and the fluid relief arrangement 1212 that are patterned thereon, according to some embodiments of the disclosure. FIG. 14 also shows a Detail C of one of the standoffs 1210, according to some embodiments of the disclosure. FIG. 15 is an expanded view of a Detail B of FIG. 14, showing more details of the fluid relief arrangement 1212, according to some embodiments of the disclosure. FIG. 16 is a cross-sectional view of a portion of the fluid relief arrangement 1212 of the diaphragm 136 taken along Line E-E of FIG. 14, according to some embodiments of the disclosure. FIG. 17 is an expanded view of a Detail F of the fluid relief arrangement 1212 of FIG. 15, according to some embodiments of the disclosure.

In the examples of the diaphragm pump 134 and the diaphragm 136 shown in FIG. 11 through FIG. 17, the diameter of the diaphragm pump 134 is about 0.366 inches and the combined diameter of both the diaphragm pump 134 and the connecting portion 137 is about 0.453 inches. The thickness of the diaphragm pump 134 is about 0.024 inches. The thickness of the connecting portion 137 is about 0.012 inches. These exemplary dimensions are, of course, merely exemplary and are not intended to be construed as any kind of limitation on the disclosure provided herein.

Referring now to FIG. 18A, FIG. 18B, FIG. 18C, FIG. 19, and FIG. 20, various views of one example of the input valve 132 and/or the outlet valve 142 of the pump assembly 110 are shown. Namely, FIG. 18A is a perspective view of an example of the input valve 132 and/or the outlet valve 142. FIG. 18B is a plan view of an example of the input valve 132 and/or the outlet valve 142 shown in FIG. 18A. FIG. 18C is a side view of an example of the input valve 132 and/or the outlet valve 142 shown in FIG. 18A. FIG. 19 is a cross-sectional view of an example of the input valve 132 and/or the outlet valve 142 taken along Line A-A of FIG. 18C. In this view, the input valve 132 and/or the outlet valve 142 is in the open state. FIG. 20 is a cross-sectional view of the input valve 132 and/or the outlet valve 142 taken along Line B-B of FIG. 18B. In this view, the input valve 132 and/or the outlet valve 142 is in the deflected state.

In the example shown in FIG. 18A, FIG. 18B, FIG. 18C, FIG. 19, and FIG. 20, the deflecting portion of the input valve 132 and/or the outlet valve 142 has a width of about 0.012 inches and a length of about 0.157 inches. These exemplary dimensions are, of course, merely exemplary and are not intended to be construed as any kind of limitation on the disclosure provided herein.

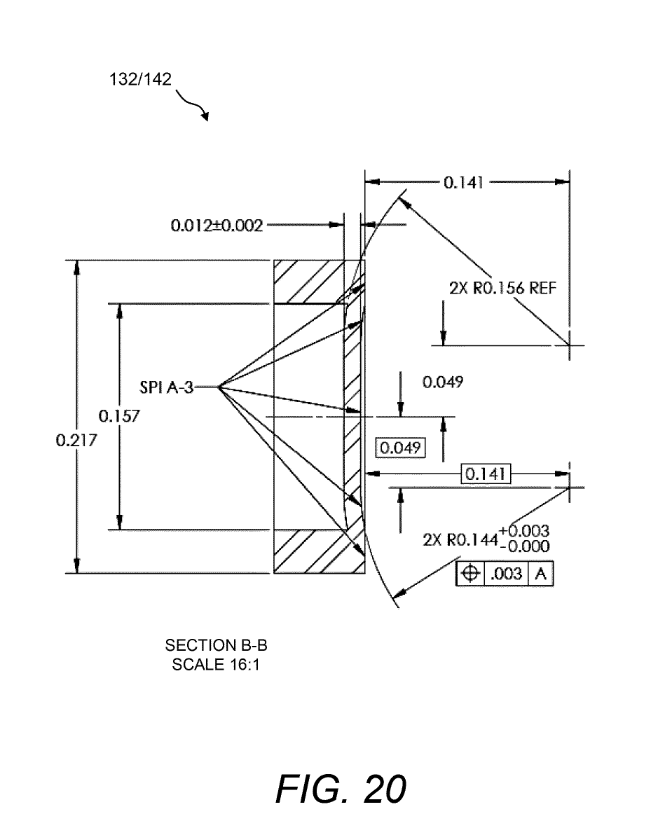

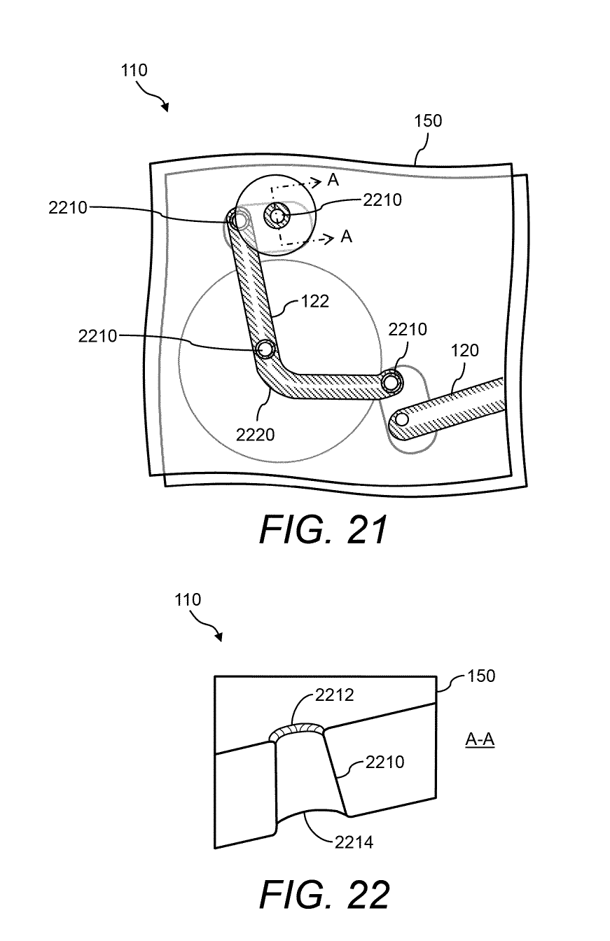

In a fluid delivery system, poor flow characteristics may be undesirable. For example, poor flow characteristics may allow for an accumulation of proteins from, for example, the treatment fluid 180 flowing along the fluid flow paths, which can lead to the growth of bacteria and reduced efficacy of the drug. Namely, locations along the flow path that have sharp angles are potential locations creating poor flow characteristics, such as for example, trapping and accumulating proteins. For example, a 90-degree bend in the flow path or the flow path having a square or rectangular cross-section have the potential for trapping and accumulating proteins. In the presently disclosed fluid delivery system 100, sharp bends (e.g., 90-degree bends) may be replaced with radius bends in order to provide optimized flow characteristics. Examples of such radius bends are illustrated and described hereinbelow with reference to FIG. 21 through FIG. 26. Referring now to FIG. 21, a plan view of a portion of one pump assembly 110 is depicted, showing more details of the fluid paths therein, wherein the fluid paths have optimized flow characteristics. In pump assembly 110, if the fluid channels 120 and/or 122 are considered horizontal flow paths, then the inlet and outlets of, for example, the input valve 132, the diaphragm pump 134, and the outlet valve 142 can be considered vertical flow paths. By way of example, FIG. 21 shows a plurality of vertical flow paths 2210 present along the fluid channel 122.

Referring now to FIG. 22, a cross-sectional view of an example of the vertical flow path 2210 taken along Line A-A of FIG. 21 is shown. In this example, the vertical flow path 2210 is tapered. Namely, if the direction of flow is from an inlet 2212 toward an outlet 2214, then the diameter of the inlet 2212 may be smaller than the diameter of the outlet 2214. In some embodiments, the preferred taper angle is 14 degrees. Accordingly, abrupt transitions in the pressure profile between the vertical walls are prevented. Specifically, the boundary layer in the vertical flow path is minimized such that the gradient of the pressure profile is minimized, thereby minimizing extension, compression, and/or torsion stresses on objects that may be suspended in the fluid (e.g. living cells). Further, the inlet 2212 has a radius edge and not a sharp edge. This radius edge further minimizes the pressure gradient as well as reducing the pressure drop through the system and increasing pump efficiency. Minimizing the stress on objects that may be suspended in the fluid may be important for certain applications wherein, for example, living cells need to remain alive and undamaged while being pumped through the system. In some exemplary embodiments, the radius edge may have a radius of about 0.004 inches.

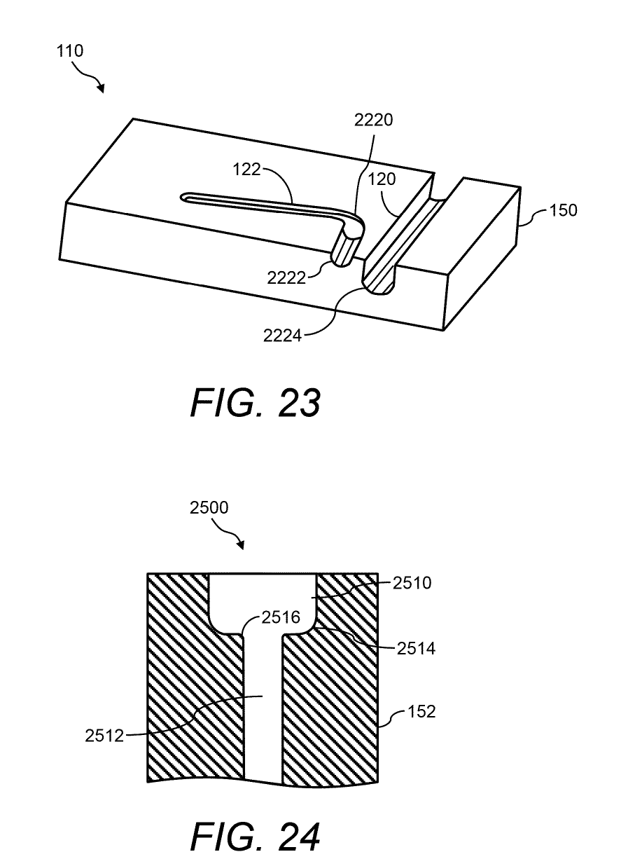

Referring again to FIG. 21, the fluid channel 122 may have a radius bend 2220 and not a sharp bend. Further, the fluid channels 120 and/or 122 may include radius edges in their cross-sections, more details of which are shown in FIG. 23. Referring now to FIG. 23, a cutaway perspective view of a portion of one pump assembly 110 is shown, detailing additional features of the fluid channels 120 and 122. Namely, FIG. 23 shows the radius bend 2220 in the fluid channel 122, which can have, for example, an outside radius of about 0.110 inches and an inside radius of about 0.047 inches.

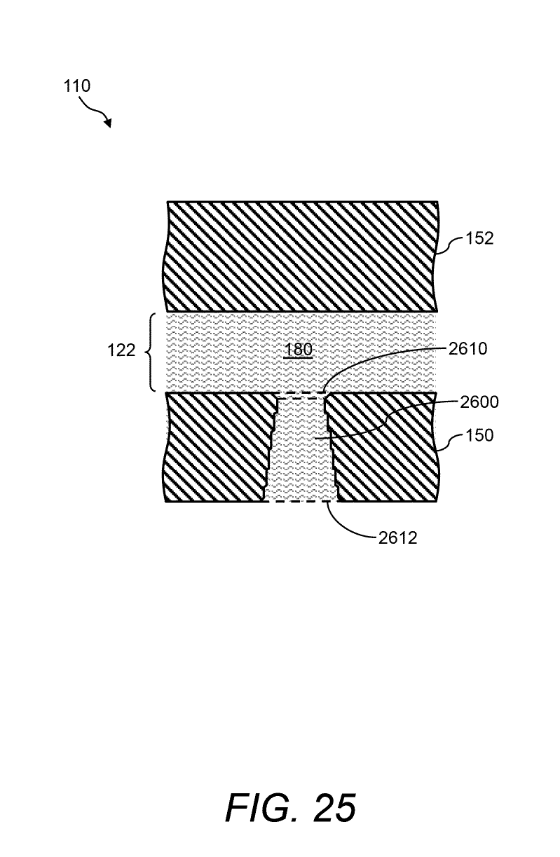

FIG. 23 also shows that the fluid channel 122 may also include a cross-sectional radius bend 2222. Similarly, the fluid channel 120 may include a cross-sectional radius bend 2224. The cross-sectional radius bend may have, in some embodiments, a radius of about 0.030 inches. Referring now to FIG. 24, a cross-sectional side view of an example of an inlet port 2500 of the pump assembly 110 that has optimized flow characteristics is shown. The inlet port 2500 comprises a catch basin 2510 that supplies a fluid channel 2512. The lower edge of the inlet port 2500 includes a radius edge 2514. Further, the outlet of the catch basin 2510 that feeds the fluid channel 2512 has a radius edge 2516.

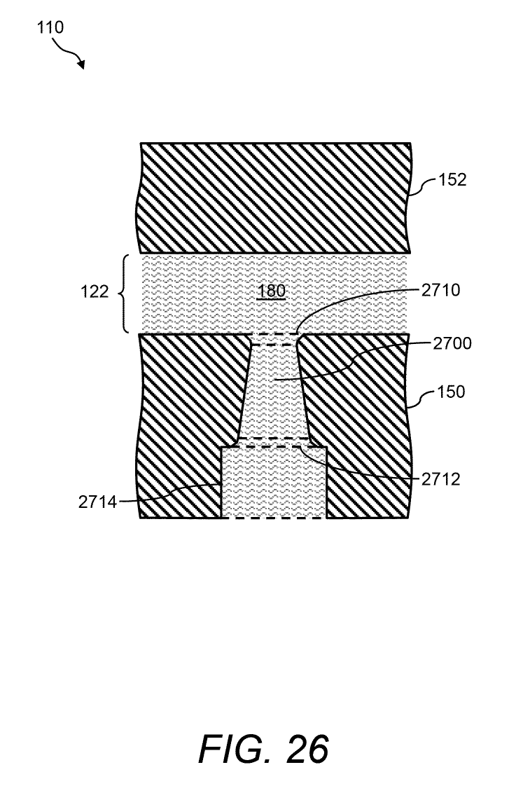

Referring now to FIG. 25 and FIG. 26, cross-sectional side views of yet other examples of an inlet/outlet of the pump assembly 110 that have optimized flow characteristics are shown. FIG. 25 shows an inlet/outlet 2600 arranged along the fluid channel 122. In this example, the inlet/outlet 2600 is tapered. Namely, if the direction of flow is from an inlet 2610 toward an outlet 2612, then the diameter of the inlet 2610 may be smaller than the diameter of the outlet 2612. Accordingly, the pressure gradient from a center of the fluid flow to the outer edge of the fluid flow may be minimized, thereby minimizing extension, compression, and torsional stresses on objects that may be suspended in the fluid (e.g. living cells). Further, the inlet 2610 may also include a radius edge or a sloped edge and not a sharp edge, further decreasing the pressure gradient from a center of the fluid flow to the outer edge of the fluid flow and also increasing pump efficiency.

FIG. 26 shows an inlet/outlet 2700 arranged along the fluid channel 122. In this example, the inlet/outlet 2700 is once again tapered. Namely, if the direction of flow is from an inlet 2710 toward an outlet 2712, then the diameter of the inlet 2710 is smaller than the diameter of the outlet 2712. Accordingly, the pressure gradient from a center of the fluid flow to the outer edge of the fluid flow may be minimized, thereby minimizing extension, compression, and torsional stresses on objects that may be suspended in the fluid (e.g. living cells). Further, the inlet 2710 may also include a radius edge or a sloped edge and not a sharp edge, further decreasing the pressure gradient from a center of the fluid flow to the outer edge of the fluid flow and also increasing pump efficiency. The outlet 2712 may supply a coupling feature 2714 that is designed to mate to, for example, the second end 17 of the injection delivery devices 10. In this example, the outlet 2712 may also have a radius edge or a sloped edge and not a sharp edge.

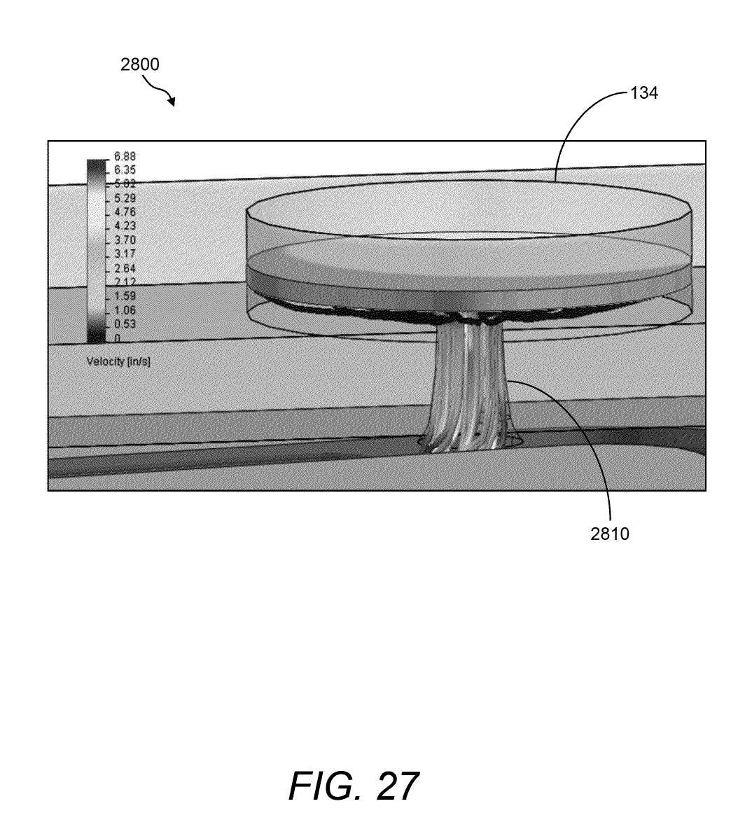

Referring now to FIG. 27, a plot 2800 of the outlet flow path of the diaphragm valve 134 and showing an example of the flow velocity streamlines. Namely, the plot 2800 shows the flow velocity streamlines 2810.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A fluid delivery system comprising a plurality of pump assemblies, the pump assemblies comprising a membrane pump and a plurality of membrane valves interconnected by fluid channels, wherein the membrane pump and plurality of membrane valves comprise a diaphragm configured in open and closed positions for metering out and dispensing predetermined amounts of a fluid treatment substance from a fluid reservoir fluidly connected to the pump assemblies via the fluid channels, and further wherein the membrane pump and plurality of membrane valves comprises a pressure/vacuum chamber and a resilient membrane layer having a bottom side for at least partial contact with a first substrate of the pressure/vacuum chamber, wherein the resilient membrane layer comprises a plurality of standoffs disposed on the bottom side configured for preventing total contact with the first substrate.

2. The fluid delivery system of claim 1, wherein the standoffs comprise a base end and a terminus end and further wherein the base end is coupled to the resilient membrane layer bottom side and the standoffs are tapered from the base end to the terminus end such that the terminus end has a smaller cross-sectional area than the base end.

3. The fluid delivery system of claim 2, wherein the standoffs are substantially conical or semi-spherical.

4. The fluid delivery system of claim 1, wherein the diaphragm further comprises a fluid relief arrangement disposed on the bottom side of the resilient membrane layer.

5. The fluid delivery system of claim 4, wherein the fluid relief arrangement is configured in a snowflake pattern.

6. The fluid delivery system of claim 5, wherein the snowflake pattern has three branches.

7. The fluid delivery system of claim 6, wherein the standoffs are patterned between the three branches of the snowflake pattern.

8. The fluid delivery system of claim 1, wherein the resilient membrane layer of the diaphragm comprises a diaphragm portion encircled by a connecting portion, the connecting portion having a thickness less than that of the diaphragm portion, wherein the diaphragm portion is configured to contact a second substrate of the pressure/vacuum chamber during the open condition thereby causing a consistent metered amount of dispensed fluid treatment substance.

9. The fluid delivery system of claim 8, wherein the connecting portion is tapered in thickness from less thick on an outer perimeter to more thick at a point where the connecting portion couples to the diaphragm portion.

10. The fluid delivery system of claim 8, wherein the connecting portion is substantially uniform in thickness, thereby resulting in a step between the connecting portion and the thicker diaphragm portion.

11. The fluid delivery system of claim 1, wherein the fluid channels comprise optimized flow characteristics, the optimized flow characteristics comprising radius bends and radius cross-sections within the fluid channels.

12. The fluid delivery system of claim 1 further comprising inlet/outlet ports along the fluid channels, wherein the inlet/outlet ports are tapered such that the fluid entering the port flows through an inlet having a diameter less than that of the outlet thereby minimizing the boundary layer and minimizing the pressure gradient from a center of the fluid flow to the outer edge of the fluid flow.

13. The fluid delivery system of claim 12, wherein the inlet/outlet ports further comprise a radius around the perimeter of the inlet.

14. A fluid delivery system comprising a plurality of pump assemblies, the pump assemblies comprising a membrane pump and a plurality of membrane valves interconnected by fluid channels coupled to the membrane pump and plurality of membrane valves via inlet/outlet ports, wherein:
the fluid channels comprise radius bends and radius cross-sections within the fluid channels;
the inlet/outlet ports are tapered such that the fluid entering the port flows through an inlet having a diameter less than that of the outlet thereby minimizing the boundary layer and minimizing the pressure gradient from a center of the fluid flow to the outer edge of the fluid flow, and the inlet further comprises a radius edge around the perimeter; and
the membrane pump and plurality of membrane valves comprise a diaphragm configured in open and closed positions for metering out and dispensing predetermined amounts of a fluid treatment substance from a fluid reservoir fluidly connected to the pump assemblies via the fluid channels, and further wherein the diaphragm comprises a pressure/vacuum chamber and a resilient membrane layer having a bottom side for at least partial contact with a first substrate of the pressure chamber, wherein the resilient membrane layer comprises a plurality of standoffs disposed on the bottom side configured for preventing total contact with the first substrate.

15. The fluid delivery system of claim 14, wherein the standoffs comprise a base end and a terminus end and further wherein the base end is coupled to the resilient membrane layer bottom side and the standoffs are tapered from the base end to the terminus end such that the terminus end has a smaller cross-sectional area than the base end.

16. The fluid delivery system of claim 14, wherein the standoffs are substantially conical or semi-spherical.

17. The fluid delivery system of claim 14, wherein the diaphragm further comprises a fluid relief arrangement disposed on the bottom side of the resilient membrane layer.

18. The fluid delivery system of claim 17, wherein the fluid relief arrangement is configured in a snowflake pattern.

19. The fluid delivery system of claim 18, wherein the snowflake pattern has three branches.

20. The fluid delivery system of claim 19, wherein the standoffs are patterned between the three branches of the snowflake pattern.

21. The fluid delivery system of claim 14, wherein the resilient membrane layer of the diaphragm comprises a diaphragm portion encircled by a connecting portion, the connecting portion having a thickness less than that of the diaphragm portion, wherein the diaphragm portion is configured to contact a second substrate of the pressure chamber during the open condition thereby causing a consistent metered amount of dispensed fluid treatment substance.

22. The fluid delivery system of claim 21, wherein the connecting portion is tapered in thickness from less thick on an outer perimeter to more thick at a point where the connecting portion couples to the diaphragm portion.

23. The fluid delivery system of claim 21, wherein the connecting portion is substantially uniform in thickness, thereby resulting in a step between the connecting portion and the thicker diaphragm portion.
